(19) United States
(12) Patent Application Publication
(10) Pub. No.: US 2020/0210930 A1
(43) Pub. Date: Jul. 2, 2020

(54) Method and System for Managing an Event Engaged by a Group of Participants in Real-Time

(71) Applicant: Wipro Limited, Bangalore (IN)

(72) Inventors: Meenakshi Sundaram Murugeshan, Bangalore (IN); Dr. Gopichand Agnihotram, Bangalore (IN)

(21) Appl. No.: 16/281,557

(22) Filed: Feb. 21, 2019

(30) Foreign Application Priority Data
Dec. 28, 2018 (IN) 201841049710

(51) Int. Cl. G06Q 10/06; G06F 16/22; G06N 3/08; G06F 17/27

(52) U.S. Cl. CPC G06Q 10/063112; G06F 17/2765; G06N 3/08; G06F 16/2272

(57) ABSTRACT

Embodiments of present disclosure relates to robust and efficient, method and system for managing event engaged by participants in real-time. Initially, input data is received through multiple inputs modes. The input data includes text, audio, image, video, and gesture, associated with event and participants. Further, each participant is profiled, during event. Profiling is based on input data and pre-stored event data associated with event. Behavioural attributes of each participant is indexed based on input data, pre-stored event data and profiling of corresponding participant. Alerts are generated to provide to at least one participant, during event. The alerts are generated based on profiling and indexing of corresponding participant, input data and pre-stored event data. Upon end of event, event data is determined for event and participants, based on profiling, and indexing of participants. By this, event is managed efficiently and dynamically, with real-time alerts and recommendations.

### TECHNICAL FIELD

The present subject matter is related in general to managing systems, more particularly, but not exclusively to a method and system for managing an event engaged by group of participants in real-time.

### BACKGROUND

In conventional systems and methods, tracking participants contribution in real-time remains challenging as automated systems which are currently existing needs to evaluate based on certain parameters such as attentiveness, group collaboration skills, completion of assigned tasks and so on. Further, in the conventional systems and methods, the participant may drive meetings or group discussions where the participant will be maintaining a set of physical records corresponding to topics and derives inferences of meeting corresponding to the topic. Further, the participant will be suggesting the ways to improve the other participants in the meeting and can help in arriving at the qualitative measures to follow such as good coordination, areas of improvement, and the like.

In an example, multi-party conversations such as project review meetings, interviews, or any other meetings happen involving multiple people and multiple rounds of discussion takes place. In such kind of discussions, it is very much important and critical to drive the conversation effectively and further evaluate the contribution of each member on various kinds of aspects. Each of the member's contribution is not only based on the tasks completed. The following are the key aspects such as time taken for each task to complete, interpersonal relationship score, group collaboration score, and attention co-ordination score (which determines the alertness and proactive skills of the user) that are used to evaluate the contribution of each team member.

Some of the existing systems to manage the events disclose to capture initiation of meetings and record the meeting content. This may be used to index and identify the context or topics discussed and used to generate summaries of the meeting. Other existing systems may disclose to obtain an audio signal collected from a video conference signal and converting the audio signal into text. This may be correlated to form a conference summary. However, none of the systems teach to dynamically manage an event based on real-time data. Also, none of the systems disclose to inference the event based on the real-time data.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method of managing an event engaged by a group of participants, in real-time. Initially, an input data is received through multiple inputs modes associated with the event engaged by the group of participants. The input data includes at least one of text data, audio data, image data, video data and gesture data, associated with the event and the group of participants. Further, each participant from the group of participants is profiled, during the event. The profiling is based on the input data and a pre-stored event data associated with the event. One or more behavioural attributes of each participant from the group of participants is indexed based on at least one of the input data, the pre-stored event data, and the profiling of corresponding participant. One or more alerts are generated to provide to at least one participant from the group of participants, during the event. The one or more alerts are generated based on the profiling and the indexing of the corresponding participant, the input data, and the pre-stored event data. Upon end of the event, an event data is determined for the event and the group of participants, based on the profiling and the indexing of the group of participants.

In an embodiment, the present disclosure relates to an event managing system for managing an event engaged by a group of participants, in real-time. The event managing system includes a processor and a memory communicatively coupled to the processor. The memory stores processor-executable instructions, which on execution cause the processor to manage the event. Initially, an input data is received through multiple inputs modes associated with the event engaged by the group of participants. The input data includes at least one of text data, audio data, image data, video data and gesture data, associated with the event and the group of participants. Further, each participant from the group of participants is profiled, during the event. The profiling is based on the input data and a pre-stored event data associated with the event. One or more behavioural attributes of each participant from the group of participants is indexed based on at least one of the input data, the pre-stored event data, and the profiling of corresponding participant. One or more alerts are generated to provide to at least one participant from the group of participants, during the event. The one or more alerts are generated based on the profiling and the indexing of the corresponding participant, the input data, and the pre-stored event data. Upon end of the event, an event data is determined for the event and the group of participants, based on the profiling and the indexing of the group of participants.

In an embodiment, the present disclosure relates to a non-transitory computer readable medium including instructions stored thereon that when processed by at least one processor cause a device to perform operations to manage an event engaged by a group of participants, in real-time. Initially, an input data is received through multiple inputs modes associated with the event engaged by the group of participants. The input data includes at least one of text data, audio data, image data, video data and gesture data, associated with the event and the group of participants. Further, each participant from the group of participants is profiled, during the event. The profiling is based on the input data and a pre-stored event data associated with the event. One or more behavioural attributes of each participant from the group of participants is indexed based on at least one of the input data, the pre-stored event data, and the profiling of corresponding participant. One or more alerts are generated to provide to at least one participant from the group of participants, during the event. The one or more alerts are generated based on the profiling and the indexing of the corresponding participant, the input data, and the pre-stored event data. Upon end of the event, an event data is determined for the event and the group of participants, based on the profiling and the indexing of the group of participants.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment of event managing system for managing an event engaged by a group of participants, in real-time, in accordance with some embodiments of the present disclosure;

FIG. 2 shows a detailed block diagram of an event managing system for managing an event engaged by a group of participants, in real-time, in accordance with some embodiments of the present disclosure;

FIGS. 3a and 3b illustrate exemplary scenarios for managing an event engaged by a group of participants, in real-time, in accordance with some embodiments of present disclosure;

FIG. 4a illustrates a flowchart showing an exemplary method for managing an event engaged by a group of participants, in real-time, in accordance with some embodiments of present disclosure;

FIG. 4b illustrates a flowchart showing an exemplary method for generating one or more alerts during an event, in accordance with some embodiments of present disclosure;

FIG. 4c illustrates a flowchart showing an exemplary method for detecting occurrence of a deviation in context of an event, in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure relates to an event managing system 101 for managing an event engaged by group of participants. The proposed system is configured to receive data associated with the participant and the event to generate individual participant profile. Real-time data is retrieved during the event to index behavioural attributes of the participants. Also, considering the profiling and the indexing and based on on-going topic of the event and context of the event, one or more alerts are generated to at least one participant. The proposed system is an automated system which is configured to dynamically manage the event and provide inferences of the event along with progress of each participant, upon end of the event.

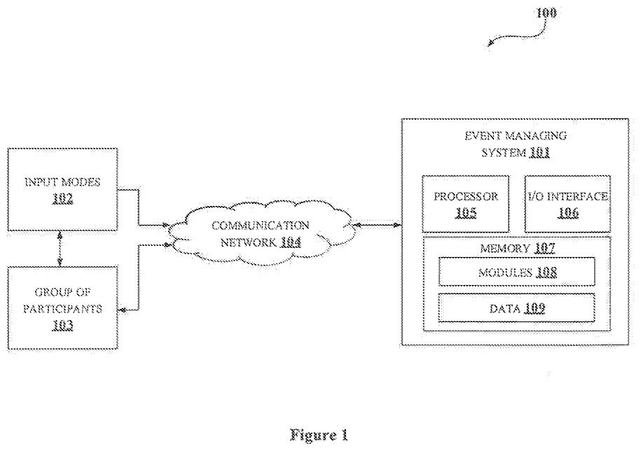

FIG. 1 shows an exemplary environment 100 of an event managing system 101 for managing an event engaged by a group of participants, in real-time. The exemplary environment 100 may include the event managing system 101, input modes 102, group of participants 103 and a communication network 104. The event managing system 101 may be configured to perform the steps of the present disclosure. The event may consist the group of participants 103, communicating with each other. For example, the event may be an official meeting between colleagues or a group discussion organized between interview candidates or a seminar or presentation presented by a speaker to audience and so on. The event managing system 101 may be implemented for any event which requires to be managed. The group of participants 103 may vary based on the event. For example, the group of participants 103 may include colleagues, if the event is an official meeting. The group of participants 103 may include interview candidates, if the event is a group discussion. The group of participants 103 may include audience, if the event is a presentation. The input modes 102 may be associated with the event to retrieve input data of the event and the group of participants 103. The input data may include any information associated with the event and the group of participants 103. For example, the input data may include number of participants 103 and details of the participants 103, slides or documents related to the event and, audio, gestures, expressions, images, and videos of the participants 103 and so on. The inputs modes may be at least one of user interface, microphone, image capturing unit, video capturing unit, gesture detection unit, expression identification unit, scanner unit, sensor related units and so on. In an embodiment, all possible information associated with the event and the group of participants 103 may be retrieved using the input modes 102. One or more other modes, known to a person skilled in the art, may be associated with the event managing system 101, to receive the input data. In an embodiment, the event managing system 101 may communicate with at least one of the input modes 102 and the group of participants 103 through the communication network 104. The event managing system 101 may receive the input data via the communication network 104. The input data may be retrieved from the group of participants 103 via the input modes 102. In an embodiment, the event managing system 101 may be associated with an event where the group of participants 103 may be located at remote locations but participating in the event. The input data from each participant may be collected by the input modes 102 located at vicinity of the corresponding participant in the remote locations. In an embodiment, the communication network 104 may include, without limitation, a direct interconnection, Local Area Network (LAN), Wide Area Network (WAN), Controller Area Network (CAN), wireless network (e.g., using Wireless Application Protocol), the Internet, and the like.

Further, the event managing system 101 may include a processor 105, I/O interface 106, and a memory 107. In some embodiments, the memory 107 may be communicatively coupled to the processor 105. The memory 107 stores instructions, executable by the processor 105, which, on execution, may cause the event managing system 101 to manage the event, as disclosed in the present disclosure. In an embodiment, the memory 107 may include one or more modules 108 and data 109. The one or more modules 108 may be configured to perform the steps of the present disclosure using the data 109, to manage the event. In an embodiment, each of the one or more modules 108 may be a hardware unit which may be outside the memory 107 and coupled with the event managing system 101. The event managing system 101 may be implemented in a variety of computing systems, such as a laptop computer, a desktop computer, a Personal Computer (PC), a notebook, a smartphone, a tablet, e-book readers, a server, a network server, a cloud-based server and the like.

Initially, the event managing system 101 may be configured to receive the input data through the input modes 102 associated with the event engaged by the group of participants 103. The input data includes at least one of text data, audio data, image data, video data and gesture data, associated with the event and the group of participants 103. In an embodiment, the event managing system 101 may be configured to process the input data by performing one or more tasks associated with Natural Language Processing (NLP), for managing the event.

Further, the event managing system 101 may be configured to profile each participant from the group of participants 103, during the event. The profiling may be based on the input data and a pre-stored event data associated with the event. In an embodiment, the pre-stored data may include information associated with the event. For example, the prestored data may include schedule, venue, topics, one or more contexts associated with the event and sequence of the one or more contexts. In an embodiment, the pre-stored data may include information associated with the group of participants 103. For example, the prestored data may include skills, tasks and contexts associated with each participant from the group of the participants 103. In an embodiment, the pre-stored data may be stored in a database (not shown in FIG. 1) associated with the event managing system 101. A participant may be profiled by generating a participant-specific data and a group-specific data for the participant. The participant-specific data includes skills, tasks, topics, and activities associated with the participant with respect to context of the event. The group-specific data indicates relationship of the participant-specific data with respect to the context of the event.

Upon the profiling, the event managing system 101 may be configured to index one or more behavioural attributes of each participant from the group of participants 103. The indexing may be based on at least one of the input data, the pre-stored event data, and the profiling of corresponding participant. The one or more behavioural attributes includes an interpersonal attribute, an attention attribute, and a group co-ordination attribute. The indexing of an interpersonal attribute of a participant may be performed using the participant-specific data and the input data associated with the participant. The indexing of the attention attribute of a participant may be performed based on a participant-specific data, the input data and the one or more alerts associated with the participant. The indexing of the group co-ordination attribute of a participant may be performed based on the pre-stored event data, a group-specific data and the input data associated with the participant. In an embodiment, indexing may include assigning a value for the one or more behavioural attributes of the participant. In an embodiment, the value may range from value “0” to value “10”. In an embodiment, the value may be in form of percentage ranging from 0% to 100%.

Further, during the event, the event managing system 101 may be configured to generate one or more alerts to provide to at least one participant from the group of participants 103, during the event. The one or more alerts may be generated based on the profiling and the indexing of the corresponding participant, the input data, and the pre-stored event data. In an embodiment, the one or more alerts for the at least one participant may be generated using a trained deep neural network. Occurrence of a deviation in context of the event may be detected based on the input data and the pre-stored event data. In an embodiment, features associated with one or more input keywords from the input data may be extracted to identify at least one on-going topic in the event. The features of the one or more input keywords may be compared with features of one or more pre-stored keywords from the pre-stored event data. By the comparison, a mismatch between the one or more input keywords and the one or more pre-stored keywords may be detected. By detecting the mismatch, the occurrence of the deviation in the context may be detected. Upon detecting the occurrence of the deviation, the at least one participant associated with the occurrence may be identified. The at least one participant may be identified using the input data and the participant-specific data of the group of participants 103. The one or more alerts may be generated with respect to the deviation in context and provided to the at least one participant.

Upon end of the event, the event managing system 101 may be configured to determine an event data for the event and the group of participants 103. The event data may be determined based on the profiling and the indexing of the group of participants 103. In an embodiment, the event data for the event may include inference associated with the event. In an embodiment, the event data for a participant from the group of participants 103 may include progress data and action plan data for the participant.

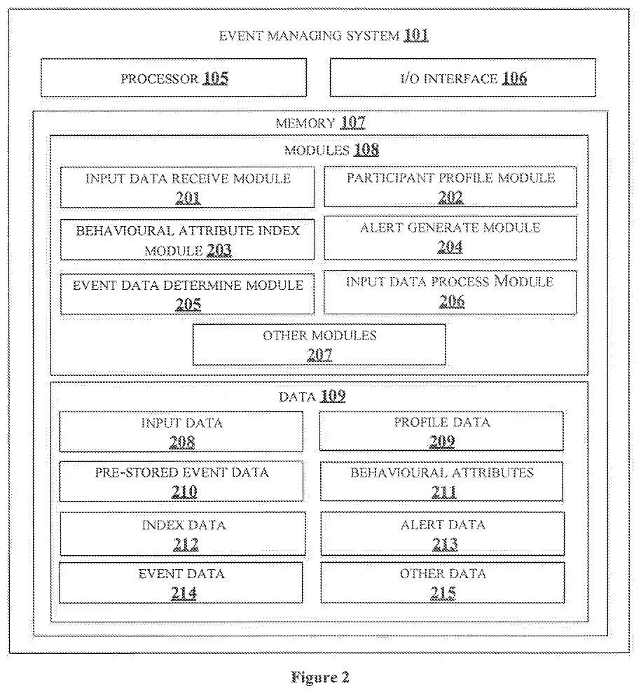

FIG. 2 shows a detailed block diagram of the event managing system 101 for managing the event in real-time, in accordance with some embodiments of the present disclosure.

The data 109 and the one or more modules 108 in the memory 107 of the event managing system 101 is described herein in detail.

In one implementation, the one or more modules 108 may include, but are not limited to, an input data receive module 201, a participant profile module 202, a behavioural attribute index module 203 and an alert generate module 204, an event data determine module 205, an input data process module 206, and one or more other modules 207, associated with the event managing system 101.

In an embodiment, the data 109 in the memory 107 may include input data 208, profile data 209, pre-stored event data 210, behavioural attributes 211 (also referred to as one or more behavioural attributes 211), index data 212, alert data 213 (also referred to as one or more alerts 213), event data 214, and other data 215 associated with the event managing system 101.

In an embodiment, the data 109 in the memory 107 may be processed by the one or more modules 108 of the event managing system 101. In an embodiment, the one or more modules 108 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

One or more modules 108 of the present disclosure function to manage the event in real-time, by generating alerts dynamically to the participants, during the event. Also, the one or more modules 108 of the present disclosure function to determine event data for the event, upon end of the event. The one or more modules 108 along with the data 109, may be implemented any system, for managing the event.

Initially, the input data receive module 201 may be configured to receive the input data 208 through the input modes 102 associated with the event engaged by the group of participants 103. The input data 208 may be received in form of the text data, the audio data, the image data, the video data, and the gesture data. In an embodiment, the input data process module 206 may be configured to process the input data 208 by performing one or more tasks associated with Natural Language Processing (NLP), for managing the event. The processed input data may be stored as the input data 208 in the memory 107. In an embodiment, the one or more tasks may include, but are not limited to, removing stop words and punctuations, performing lemmatization, and tagging Part-Of-Speech (POS) in the input data 208. Also, the one or more tasks may include, but are not limited to, mapping utterances in the input data 208 with <Argument-Relationship> information using a semantic parser. In an embodiment, details related to <Argument-Relationship> information may be obtained through a semantic parser implemented in input data receive module 201. In an embodiment, performing the semantic parsing, task specific actions in the input data 208 may be identified. For example, if an utterance from a participant is identified to be “THE MODULE IS NOT YET READY FOR DEPLOYMENT”, from the input data 208. By performing the one or more tasks, the <Argument-Relationship> information may be determined to be <Module—Not completed>. By such tasks, inference of actions performed by each participant from the group of participants 103 may be generated. Further, by performing the one or more tasks, the processed input data 208 may be used to profile each participant from the group of participants 103, index the one or more behavioural attribute of the group of participants 103 and generate the one or more alerts 213.

Further, the participant profile module 202 may be configured to profile each participant from the group of participants 103, during the event. The profiling may be based on the input data 208 and a pre-stored event data 210 associated with the event. For profiling a participant, the input data 208 may include gestures, actions, opinions, associated with the participant. The actions of the participants 103 may include scrolling of a document, looking at the document, writing notes, and so on. In an embodiment, the input data 208 may also include voice specific sentiments of the participant, for profiling the participants. In an embodiment, the pre-stored data may include information such as tasks associated with the participant, frequency of common emails shared, data in subject line of the emails, filtered dialog acts (i.e., affirmative/negation/repeated utterances of a participant) associated with participants and tasks, time period of the task discussed, status of the tasks (i.e., if the task is completed, percentage of completion, discussions involved, not discussed over a period and so on), shared tasks, and member information from bug-reports and so. Further, for the profiling the participant-specific data and the group-specific data may be generated for the participant. The participant profile module 202 may implement an adaptive learning to generate and dynamically update the participant-specific data and the group-specific data for the participant. In an embodiment, each of the participant-specific data and the group-specific data may be stored in as the profile data in the memory 107. In an embodiment, the each of the participant-specific data and the group-specific data may be in stored in as vector representation.

In an embodiment, the participant-specific data may include user specific information such as skills, task-assigned, topics discussed in emails and so on. Consider “P” is the participant-specific data for the participant. Vector representation of P may be as in equation 1, given below:

Pᵢ=(S₁ᵢ,T₁ᵢ,TP₁ᵢ,I₁ᵢ,I₂ᵢ, . . . ) (1)

where Pᵢ is the participant-specific data for the i^{th} participant,

S₁ᵢ is skills associated with the i^{th} participant;

T₁ᵢ is tasks associated with the i^{th} participant;

TP₁ᵢ is topic associated with the i^{th} participant;

I₁ᵢ is attention coordination index of the i^{th} participant; and

I₂ᵢ is inter personal index of the i^{t} participant.

In an embodiment, the skills S₁ᵢ and the tasks T₁ᵢ may be represented as in equations 2 and 3, respectively, given below:

S₁ᵢ=(s₁,s₂,s₃ . . . ,sₙ) (2)

T₁ᵢ=(t₁,t₂,t₃ . . . ,tₙ) (3)

In an embodiment, the participant-specific data may be updated when new information is available for the participant. In an example, consider a scenario where a java related project discussion is happening in a conference room and it may be identified that a new skill of “machine learning” is required to be known by the participant along with JAVA, J2EE, and SPARK. New skill i.e., the “machine learning” is updated in S₁ᵢ.

In an embodiment, the text data from the input data 208 may be tokenized into one or more input keywords. The one or more input keywords may be used to identify intent of the topic on which the participant is discussing in the event. For example, “power point presentation” is a trigram, which provides irrelevant meaning while words are considered individually in utterance of the participant from meeting logs, mails, and tasks assigned and skills. In an embodiment, co-occurrence features along with topics discussed in the event may help in generating real-time action predictions. Such real-time action predictions may be included in the participant-specific data of the participant.

In an embodiment, the group-specific data for a participant may be include relationship of the participant-specific data with respect to the context of the event. For example, task of a participant with respect to the context of the user may be included in the group-specific data. When the task is debugging an error for deployment of a project. Such task may be the group-specific data.

Upon the profiling, the behavioural attribute index module 203 may be configured to index one or more behavioural attributes 211 of each participant from the group of participants 103. The indexing may be based on at least one of the input data 208, the pre-stored event data 210, and the profiling of corresponding participant. The one or more behavioural attributes 211 includes the interpersonal attribute, the attention attribute, and the group co-ordination attribute. Any other attribute relating to the behaviour of a participant, may be included as the one or more behavioural attributes 211. In an embodiment, the indexed values of the one or more behavioural attributes 211 may be stored as the index data 212.

The indexing of the interpersonal attribute of a participant may be performed using the participant-specific data and the input data 208 associated with the participant. For example, in an application, which is built for a virtual interviewer with avatar, everyone's inter personal relationship or coordination is analysed by analyzing the textual information, vision, and voice inputs from the individual in group discussion or individual interviews. This will help the application to take a decision to select the person or not. In an embodiment, the interpersonal index refers to strength of association between any two-participants. Each participant interacts with others based on the common tasks and their dependencies. A matrix representing the strength of association among participants may be built and dynamically updated based on the shared tasks and their frequency of interaction using one or more features such as frequency of specific mails. In an embodiments, one on one discussions in the meetings, common tasks assigned and worked and criticality of the tasks, on-time completion of the tasks during shared tasks may also be considered for indexing the interpersonal attribute.

The indexing of the attention attribute of a participant may be performed based on the participant-specific data, the input data 208 and the alert data 213 associated with the participant. In an embodiment the indexing of the inter-personal attribute may be used for indexing the attention attribute. Further, the indexing of the attention attribute may be used to pro-actively alert the participants while relevant topics are discussed to make sure that the participant is following the instructions/paying attention to the ongoing presentation. In an embodiment, the attention index may be indexed using frequency of deviation from the discussed topics during meetings, time taken to provide updates on tasks, frequency and types of clarification questions asked in meeting, alerts required are provided to the participant to bring back to the ongoing topic and so on.

The indexing of the group co-ordination attribute of a participant may be performed based on the pre-stored event data 210, the group-specific data and the input data 208 associated with the participant. In an embodiment, the tasks and their action/opinion association derived from semantic parsing, frequency of common emails shared, email subject, the filtered dialog acts associated with participants and tasks, recent task discussed, associated with decay factor that reaches “0” if the topic/task is completed/not discussed over a period, shared tasks and participant information from bug-reports may be used for the indexing. In an embodiment, the pre-stored data may include historical information such as meeting agenda (i.e., the information on topics to be covered), e-mail communications, presentations, and timeline based Minutes of the Meeting (MoM), meeting logs, design documents, and so on.

Further, during the event, the alert generate module 204 of the event managing system 101 may be configured to generate the one or more alerts 213 to provide to at least one participant from the group of participants 103, during the event. The one or more alerts 213 may be generated based on the profiling and the indexing of the corresponding participant, the input data 208, and the pre-stored event data 210. In an embodiment, the one or more alerts 213 for the at least one participant may be generated using a trained deep neural network. In an embodiment, the trained model may be a Long Short Term Memory (LSTM) model is implemented to learn context, proactively alert, and dynamically generate recommendations to task specific participants when a relevant topic deviation occurs during the event. In an embodiment, the LSTM model may be configured to perform semantic parsing of the input data 208 to learn the context of the event and detect the deviation in the context. In an embodiment, the deviation of the context may include switch in the context of the event and also discrepancy in sequence of activities of the event. In an embodiment, the sequence of activities may be stored as the pre-stored data. The set of activities may be used by the LSTM model for predicting next activity based on current activity. If the predicted activity is not part of topic assigned, the LSTM model may be configured to predict the deviation.

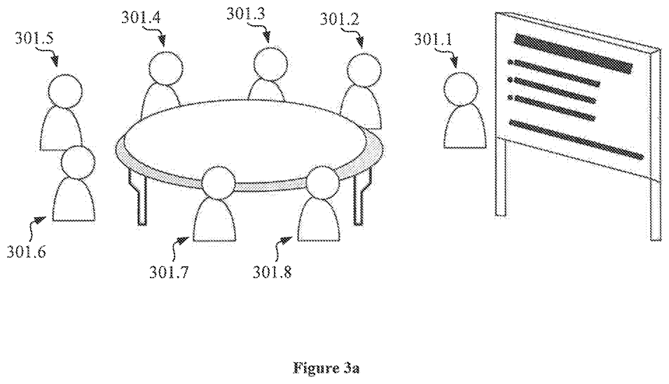

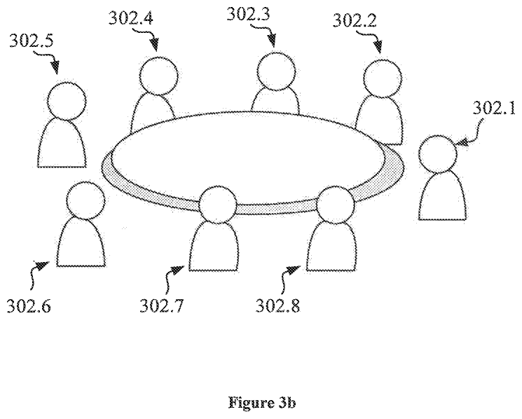

Occurrence of a deviation in context of the event may be detected based on the input data 208 and the pre-stored event data 210. In an embodiment, features associated with one or more input keywords from the input data 208 may be extracted to identify at least one on-going topic in the event. The features of the one or more input keywords may be compared with features of one or more pre-stored keywords from the pre-stored event data 210. By the comparison, a mismatch between the one or more input keywords and the one or more pre-stored keywords may be detected. By detecting the mismatch, the occurrence of the deviation in the context may be detected. Upon detecting the occurrence of the deviation, the at least one participant associated with the occurrence may be identified. The at least one participant may be identified using the input data 208 and the participant-specific data of the group of participants 103. The one or more alerts 213 may be generated with respect to the deviation in context and provided to the at least one participant. Consider a scenario illustrated in FIG. 3b. The event may be a group discussion with group of participant 302.1 . . . 302.8. Consider the topic is “Social Media Scams”. During the course of the discussion, when the topic switches to “Potential Preventive Measures”, then the participants reaction to the new context is monitored. Based on the input data 208 from the participants, the at least one participant involved in the topic switch may be identified. Consider, participant 302.2 initiated the topic switch, and participant 302.4 and participant 302.7 are continuing to discuss on the “Potential Preventive Measures”. Hence, participants 302.2, 302.4 and 302.7 may be alerted.

Consider a scenario illustrated in FIG. 3a. The event may be a project review meeting with group of participant 301.1 . . . 301.8. The pre-stored data associated with the project review meeting may include sequence of activities of the meeting. When the deviation in context is detected, the participants involved in it are pro-actively alerted to be attentive and effectively drive the meeting. In an embodiment, the alerts are provided to relevant team members/meeting attendees who are part of the task.

Upon end of the event, the event data determine module 205 of the event managing system 101 may be configured to determine an event data for the event and the group of participants 103. The event data 214 may be determined based on the profiling and the indexing of the group of participants 103. In an embodiment, the event data 214 for the event may include inference associated with the event. In an embodiment, the event data 214 for a participant from the group of participants 103 may include progress data and action plan data for the participant.

The other data 215 may store data, including temporary data and temporary files, generated by modules for performing the various functions of the event managing system 101. The one or more modules 108 may also include other modules 207 to perform various miscellaneous functionalities of the event managing system 101. It will be appreciated that such modules may be represented as a single module or a combination of different modules.

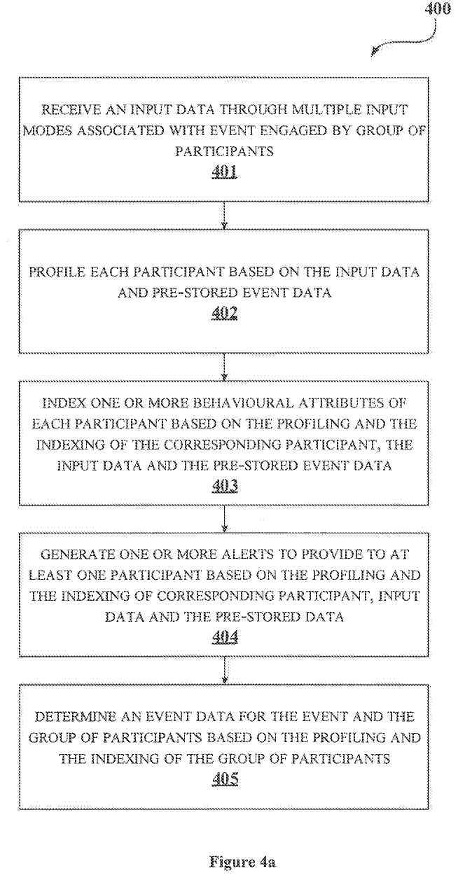

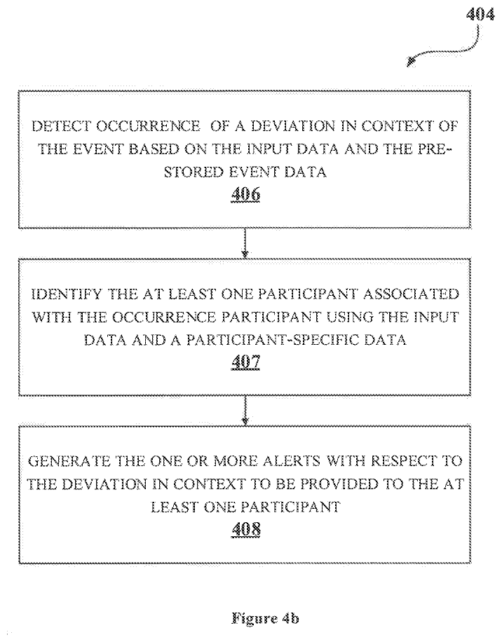

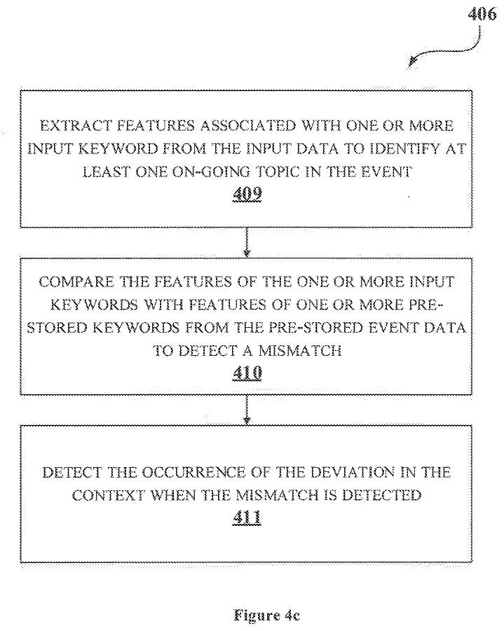

FIG. 4a illustrates a flowchart showing an exemplary method for managing the event engaged by the group of participants 103, in real-time, in accordance with some embodiments of present disclosure.

At block 401, the input data receive module 201 of the event managing system 101 may be configured to receive the input data 208 through the multiple inputs modes associated with the event engaged by the group of participants 103. The input data 208 may include at least one of the text data, the audio data, the image data, the video data, and the gesture data, associated with the event and the group of participants 103.

At block 402, the participant profile module 202 of the event managing system 101 may be configured to profile each participant from the group of participants 103, during the event. The profiling may be based on the input data 208 and the pre-stored event data 210 associated with the event.

At block 403, the behavioural attribute index module 203 of the event managing system 101 may be configured to index the one or more behavioural attributes 211 of each participant from the group of participants 103. The indexing may be based on at least one of the input data 208, the pre-stored event data 210, and the profiling of corresponding participant

At block 404, the alert generate module 204 of the event managing system 101 may be configured to generate the one or more alerts 213, to provide to at least one participant from the group of participants 103, during the event. The one or more alerts 213 may be generated based on the profiling and the indexing of the corresponding participant, the input data 208, and the pre-stored event data 210.

FIG. 4b illustrates a flowchart showing an exemplary method for generating the one or more alerts 213 during the event, in accordance with some embodiments of present disclosure.

At block 406, the alert generate module 204 of the event managing system 101 may be configured to detect the occurrence of the deviation in context of the event based on the input data 208 and the pre-stored event data 210.

FIG. 4c illustrates a flowchart showing an exemplary method for detecting the occurrence of the deviation in context of the event, in accordance with some embodiments of present disclosure.

At block 409, the alert generate module 204 of the event managing system 101 may be configured to extract the features associated with the one or more input keywords from the input data 208. The feature may be extracted to identify at least one on-going topic in the event.

At block 410, the alert generate module 204 of the event managing system 101 may be configured to compare the features of the one or more input keywords with the features of the one or more pre-stored keywords from the pre-stored event data 210. By comparing, a mismatch between the one or more input keywords and the one or more pre-stored keywords may be identified.

At block 411, the alert generate module 204 of the event managing system 101 may be configured to detect the occurrence of the deviation in the context when the mismatch is detected.

Referring back to FIG. 4b, at block 407, the alert generate module 204 of the event managing system 101 may be configured to identify the at least one participant associated with the occurrence, using the input data 208 and the participant-specific data.

At block 408, the alert generate module 204 of the event managing system 101 may be configured to generate the one or more alerts 213 with respect to the deviation in context. The one or more alerts 213 may be provided to the at least one participant from the group of participants 103.

Referring back to FIG. 4a, at block 405, the event data determine module 205 of the event managing system 101 may be configured to determine, upon end of the event, the event data 214 for the event and the group of participants 103. The event data 214 may be generated based on the profiling and the indexing of the group of participants 103.

As illustrated in FIGS. 4a, 4b and 4c, the methods 400, 404 and 406 may include one or more blocks for executing processes in the event managing system 101. The methods 400, 404 and 406 may be described in the general context of computer executable instructions. Generally, computer executable instructions can include routines, programs, objects, components, data structures, procedures, modules, and functions, which perform particular functions or implement particular abstract data types.

The order in which the methods 400, 404 and 406 are described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

### Computing System

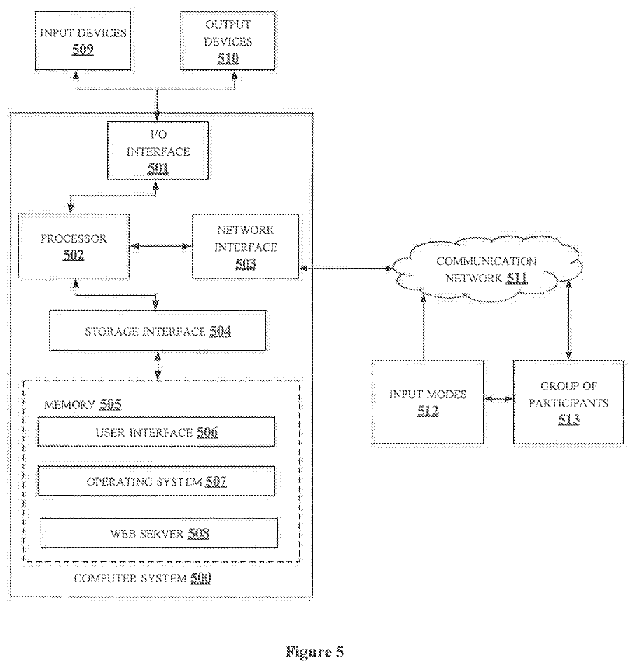

FIG. 5 illustrates a block diagram of an exemplary computer system 500 for implementing embodiments consistent with the present disclosure. In an embodiment, the computer system 500 is used to implement the event managing system 101. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via 1/O interface 501. The 1/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 may consist of the event managing system 101. The processor 502 may be disposed in communication with the communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 may communicate with input modes 512 and a group of participants 513 for managing an event in real-time. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

### Advantages

An embodiment of the present disclosure provisions to analyse every participant behavioural attributes using real-time data. By which, personal skills may be improved.

An embodiment of the present disclosure provisions assures topic of discussion to be within context of an event. Real-time alerts are generated when a deviation in context is detected.

An embodiment of the present disclosure provisions to dynamically recommend actions/constraints that will have an impact on the deliverable outcome

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 4a, 4b and 4c show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Event managing system |
| 102 | Input modes |
| 103 | Group of participants |
| 104 | Communication network |
| 105 | Processor |
| 106 | I/O interface |
| 107 | Memory |
| 108 | Modules |
| 109 | Data |
| 201 | Input data receive module |
| 202 | Participant profile module |
| 203 | Behavioural attribute index module |
| 204 | Alert generate module |
| 205 | Event data determine module |
| 206 | Input data process module |
| 207 | Other modules |
| 208 | Input data |
| 209 | Profile data |
| 210 | Pre-stored event data |
| 211 | Behavioural attributes |
| 212 | Index data |
| 213 | Alert data |
| 214 | Event data |
| 215 | Other data |
| 301.1 . . . 301.8 | Group of participants in a presentation |
| 302.1 . . . 302.8 | Group of participants in a group discussion |
| 500 | Computer System |
| 501 | I/O Interface |
| 502 | Processor |
| 503 | Network Interface |
| 504 | Storage Interface |
| 505 | Memory |
| 506 | User Interface |
| 507 | Operating System |
| 508 | Web Server |
| 509 | Input Devices |
| 510 | Output Devices |
| 511 | Communication Network |
| 512 | Input modes |
| 513 | Group of participants |

We claim:

1. A method of managing an event engaged by a group of participants, in real-time, wherein the method comprises:
receiving, by an event managing system, an input data through multiple inputs modes associated with the event engaged by the group of participants, wherein the input data comprises at least one of text data, audio data, image data, video data and gesture data, associated with the event and the group of participants;
profiling, by the event managing system, each participant from the group of participants, during the event, based on the input data and a pre-stored event data associated with the event;
indexing, by the event managing system, one or more behavioural attributes of each participant from the group of participants, based on at least one of the input data, the pre-stored event data, and the profiling of corresponding participant;
generating, by the event managing system, one or more alerts, to provide to at least one participant from the group of participants, during the event, based on the profiling and the indexing of the corresponding participant, the input data, and the pre-stored event data; and
determining, by the event managing system, upon end of the event, an event data for the event and the group of participants, based on the profiling and the indexing of the group of participants, wherein the event data for the event comprises inference associated with the event, and the event data for a participant from the group of participants comprises progress data and action plan data for the participant.

2. The method as claimed in claim 1 and further comprising:
processing, by the event managing system, the input data by performing one or more tasks associated with Natural Language Processing (NLP) for managing the event.

3. The method as claimed in claim 1, wherein the profiling of a participant comprises generating a participant-specific data and a group-specific data for the participant, wherein the participant-specific data comprises skills, tasks, topics and activities associated with the participant with respect to context of the event, and wherein the group-specific data indicates relationship of the participant-specific data with respect to the context of the event.

4. The method as claimed in claim 1, wherein the one or more behavioural attributes comprises an interpersonal attribute, an attention attribute, and a group co-ordination attribute.

5. The method as claimed in claim 1, wherein the indexing of an interpersonal attribute, from the one or more behavioural attributes, of a participant is performed using a participant-specific data and the input data associated with the participant.

6. The method as claimed in claim 1, wherein the indexing of an attention attribute, from the one or more behavioural attributes, of a participant is performed based on a participant-specific data, the input data and the one or more alerts associated with the participant.

7. The method as claimed in claim 1, wherein the indexing of a group co-ordination attribute, from the one or more behavioural attributes, of a participant is performed based on pre-stored event data, a group-specific data and the input data associated with the participant.

8. The method as claimed in claim 1, wherein generating the one or more alerts for the at least one participant is performed using a trained deep neural network by:
detecting occurrence of a deviation in context of the event based on the input data and the pre-stored event data;
identifying the at least one participant associated with the occurrence, using the input data and a participant-specific data; and
generating the one or more alerts with respect to the deviation in context, to be provided to the at least one participant.

9. The method as claimed in claim 8, wherein detecting the occurrence of the deviation in the context of the event comprises:
extracting features associated with one or more input keywords from the input data to identify at least one on-going topic in the event;
comparing the features of the one or more input keywords with features of one or more pre-stored keywords from the pre-stored event data, to detect a mismatch between the one or more input keywords and the one or more pre-stored keywords; and
detecting the occurrence of the deviation in the context when the mismatch is detected.

10. An event managing system for managing an event engaged by a group of participants, in real-time, said event monitor system comprises:
a processor; and
a memory communicatively coupled to the processor, wherein the memory stores processor-executable instructions, which, on execution, cause the processor to:
receive an input data through multiple inputs modes associated with the event engaged by the group of participants, wherein the input data comprises at least one of text data, audio data, image data, video data and gesture data, associated with the event and the group of participants;
profile each participant from the group of participants, during the event, based on the input data and a pre-stored event data associated with the event;
index one or more behavioural attributes of each participant from the group of participants, based on at least one of the input data, the pre-stored event data, and the profiling of corresponding participant;
generate one or more alerts, to provide to at least one participant from the group of participants, during the event, based on the profiling and the indexing of the corresponding participant, the input data, and the pre-stored event data; and
determine upon end of the event, an event data for the event and the group of participants, based on the profiling and the indexing of the group of participants, wherein the event data for the event comprises inference associated with the event, and the event data for a participant from the group of participants comprises progress data and action plan data for the participant.

11. The event managing system as claimed in claim 10 and further comprises the processor configured to:
process the input data by performing one or more tasks associated with Natural Language Processing (NLP) for managing the event.

12. The event managing system as claimed in claim 10, wherein a participant is profiled by generating a participant-specific data and a group-specific data for the participant, wherein the participant-specific data comprises skills, tasks, topics and activities associated with the participant with respect to context of the event, and wherein the group-specific data indicates relationship of the participant-specific data with respect to the context of the event.

13. The event managing system as claimed in claim 10, wherein the one or more behavioural attributes comprises an interpersonal attribute, an attention attribute, and a group co-ordination attribute.

14. The event managing system as claimed in claim 10, wherein the indexing of an interpersonal attribute, from the one or more behavioural attributes, of a participant is performed using a participant-specific data and the input data associated with the participant.

15. The event managing system as claimed in claim 10, wherein the indexing of an attention attribute, from the one or more behavioural attributes, of a participant is performed based on a participant-specific data, the input data and the one or more alerts associated with the participant.

16. The event managing system as claimed in claim 10, wherein the indexing of a group co-ordination attribute, from the one or more behavioural attributes, of a participant is performed based on pre-stored event data, a group-specific data and the input data associated with the participant.

17. The event managing system as claimed in claim 10, wherein the one or more alerts for the at least one participant is generated using a trained deep neural network by:
detecting occurrence of a deviation in context of the event based on the input data and the pre-stored event data;
identifying the at least one participant associated with the occurrence, using the input data and a participant-specific data; and
generating the one or more alerts with respect to the deviation in context, to be provided to the at least one participant.

18. The generating as claimed in claim 17, wherein the occurrence of the deviation in the context of the event is detected by:
extracting features associated with one or more input keywords from the input data to identify at least one on-going topic in the event;
comparing the features of the one or more input keywords with features of one or more pre-stored keywords from the pre-stored event data, to detect a mismatch between the one or more input keywords and the one or more pre-stored keywords; and
detecting the occurrence of the deviation in the context when the mismatch is detected.

19. A non-transitory computer readable medium including instructions stored thereon that when processed by at least one processor cause a device to perform operations comprising:
receiving an input data through multiple inputs modes associated with the event engaged by the group of participants, wherein the input data comprises at least one of text data, audio data, image data, video data and gesture data, associated with the event and the group of participants;
profiling each participant from the group of participants, during the event, based on the input data and a pre-stored event data associated with the event;
indexing one or more behavioural attributes of each participant from the group of participants, based on at least one of the input data, the pre-stored event data, and the profiling of corresponding participant;
generating one or more alerts, to provide to at least one participant from the group of participants, during the event, based on the profiling and the indexing of the corresponding participant, the input data, and the pre-stored event data; and
determining upon end of the event, an event data for the event and the group of participants, based on the profiling and the indexing of the group of participants, wherein the event data for the event comprises inference associated with the event, and the event data for a participant from the group of participants comprises progress data and action plan data for the participant.
